(19) United States
(12) Patent Application Publication
(10) Pub. No.: US 2009/0271993 A1
(43) Pub. Date: Nov. 5, 2009

(54) DRYWALL CUTTING APPARATUS

(76) Inventor: David M. Semprini, Hauppauge, NY (US)

Correspondence Address: THE FARRELL LAW FIRM, LLP, 290 Broadhollow Road, Suite 210E, Melville, NY, 11747, US

(21) Appl. No.: 12/433,407

(22) Filed: Apr. 30, 2009

Related U.S. Application Data
(60) Provisional application No. 61/049,104, filed on Apr. 30, 2008.

(51) Int. Cl. B26B 29/06

(52) U.S. Cl. 30/292; 30/294; 30/293; 83/745

(57) ABSTRACT

A drywall cutting apparatus is provided having a slidable mount with a top surface and a bottom surface. A channel is integrated into the bottom surface and utilized for a slidable engagement. The apparatus also includes a body having at least one side surface. The body is mounted on the top surface of the slidable mount. The apparatus further includes at least one cutting wheel mounted on the at least one side surface of the body. The at least one cutting wheel is a wheel-shaped blade that cuts as the apparatus is moved across a surface.

### PRIORITY

This application claims priority under 35 U.S.C. §119(e) to a corresponding provisional patent application, filed in the U.S. Patent and Trademark Office on Apr. 30, 2008, and assigned Ser. No. 61/049,104, the contents of which are incorporated herein by reference.

### BACKGROUND OF THE INVENTION

1. Field of the Invention

The present invention relates to a drywall cutting apparatus, and more particularly, to a drywall cutting apparatus capable of being slidably mounted and rotated upon a stem of a T-square.

2. Description of the Related Art

A conventional method of cutting a sheet of drywall involves the use of a T-square and a handheld blade. A head of the T-square is aligned with a reference edge of the drywall, and an edge of a stem of the T-square is aligned with a cut line perpendicular to the reference edge of the drywall. The handheld blade is manually slid along the edge of the aligned stem of the T-square, while holding the T-square with the other hand, cutting through the drywall at the cut line.

However, when performing the conventional drywall cutting method with a metal T-square, the handheld blade is quickly dulled when continuously slid across the edge of the T-square. When the T-square is made of a softer material, such as plastic, the handheld blade may cut into the edge of the stem of the T-square, damaging the T-square.

### SUMMARY OF THE INVENTION

The present invention has been made to address at least the above problems and/or disadvantages and to provide at least the advantages described below. Accordingly, an aspect of the present invention provides a drywall cutting apparatus capable of being slidably mounted on a T-square, and which houses at least one blade for cutting drywall.

According to one aspect of the present invention, a drywall cutting apparatus is provided having a slidable mount with a top surface and a bottom surface. A channel is integrated into the bottom surface and utilized for a slidable engagement. The apparatus also includes a body having at least one side surface. The body is mounted on the top surface of the slidable mount. The apparatus further includes at least one cutting wheel rotatably mounted on the at least one side surface of the body. The at least one cutting wheel is a wheel-shaped blade that cuts as the apparatus is moved across a surface.

According to another aspect of the present invention, a drywall cutting apparatus is provided having a mounting device that includes a slidable mount having a top surface and a bottom surface. A channel is integrated into the bottom surface and utilized for a slidable engagement. The mounting device also includes a body having at least one side surface. The body is mounted on the top surface of the slidable mount. The mounting device further includes at least one cutting wheel rotatably mounted on the at least one side surface of the body. The at least one cutting wheel is a wheel-shaped blade that cuts as the device is moved across a surface. The drywall cutting apparatus also has a T-square that includes a stem upon which the mounting device is slidably engaged, and an end stop that prevents the device from sliding off the stem when in use.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a perspective view of the components of a drywall cutting apparatus, according to an embodiment of the present invention;

FIG. 2 is a side view of the drywall cutting apparatus assembled in a first orientation, according to an embodiment of the present invention;

FIG. 3 is a top view of the drywall cutting apparatus assembled in the first orientation and mounted on a T-square, according to an embodiment of the present invention; and

FIG. 4 is a top view of the drywall cutting apparatus assembled in a second orientation and mounted on a T-square, according an embodiment of the present invention.

### DETAILED DESCRIPTION OF THE PREFERRED EMBODIMENTS

Preferred embodiments of the present invention are described in detail with reference to the accompanying drawings. The same or similar reference components are designated by the same or similar reference numerals although they are illustrated in different drawings. Detailed descriptions of constructions or processes known in the art may be omitted to avoid obscuring the subject matter of the present invention.

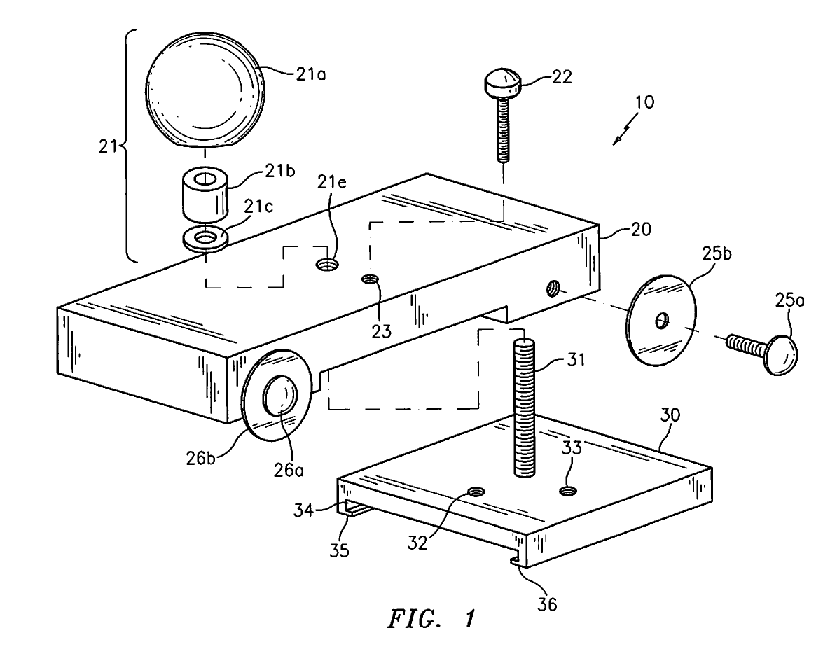

FIG. 1 is a perspective view of the components of a drywall cutting apparatus, according to an embodiment of the present invention.

Referring to FIG. 1, the drywall cutting apparatus 10 includes a main body 20, a knob assembly 21, an attachment screw 22, first and second wheel screws 25a and 26a, first and second cutting wheels 25b and 26b, a sliding mount 30, and a knob bolt 31.

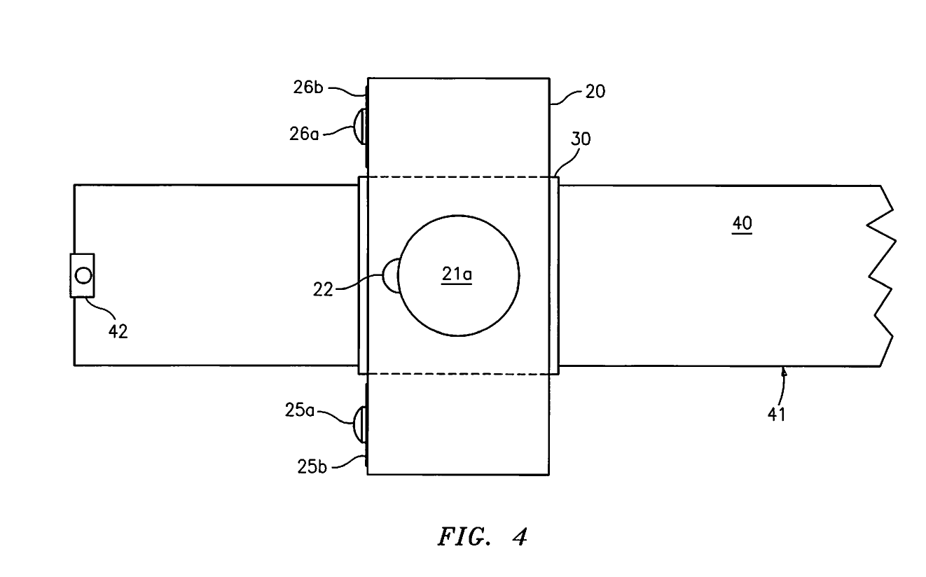

A bottom surface of the sliding mount 30 includes a channel 34 through which a stern of a T-square 40 (as shown in FIG. 4) may be slidably inserted. First and second ledges 35 and 36 are formed along the length of the channel 34, extending perpendicularly inward from the walls of the channel. The height and width of the channel 34, in combination with the first and second ledges 35 and 36, act in securing the sliding mount 30 to a T-square having standard dimensions.

The sliding mount 30 further includes a knob bolt 31, which is preferably permanently affixed to the center of a top surface of the sliding mount 30. The knob bolt 31 preferably extends upwardly from, and perpendicular to, the top surface of the sliding mount 30. The knob bolt 31 is inserted through a knob hole 21e in the main body 20. The knob assembly 21 is then screwed on to the knob bolt 31 while it extends from a top surface of the main body 20. The knob assembly 21 rotatably secures the main body 20 to the sliding mount 30. The knob assembly 21 includes a ball handle 21a, a support piece 21b, and a washer 21c. While a specific embodiment of the present invention is described, any securing mechanism may be utilized in combination with the knob bolt 31 to rotatably secure the main body 20 to the sliding mount 30.

First and second cutting wheels 25b and 26b are wheel shaped blades that are rotatably attached to a side surface of the main body 20. First and second wheel screws 25a and 26a extend through central apertures in the first and second cutting wheels 25b and 26b, respectively, and into first and second wheel holes on the side surface of the main body 20. The first and second cutting wheels 25b and 26b roll across and cut into a sheet of drywall when the drywall cutting apparatus 10 is pushed across drywall by a user. Alternative embodiments of the present invention may include the use of one cutting wheel or a plurality of cutting wheels. Further, the cutting wheels 25b and 26b may be attached to the side surface of the main body in any manner that allows the wheels to rotate, while also extending lower than the bottom surface of the sliding mount 30. It is also contemplated that the wheels may be fixedly secured so that they do not rotate.

While only attached with the knob bolt assembly, the main body 20 may rotate on the top surface of the sliding mount 30. The attachment screw 22 is inserted from the top surface of the main body 20 through attachment hole 23 in the main body 20 and can then be inserted into either one of attachment holes 32 or 33 of the sliding mount 30. The attachment screw 22 prevents rotation and secures the main body 20 to the sliding mount 30 in one of two possible orientations. Alternative embodiments of the present invention may include different numbers and placements of attachment holes in the sliding mount 30, allowing the main body 20 to be oriented in different positions. Further, alternate securing mechanisms may be utilized to secure the main body 20 in place on top of the sliding mount 30.

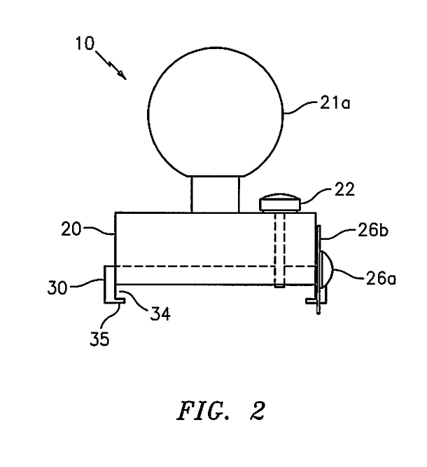

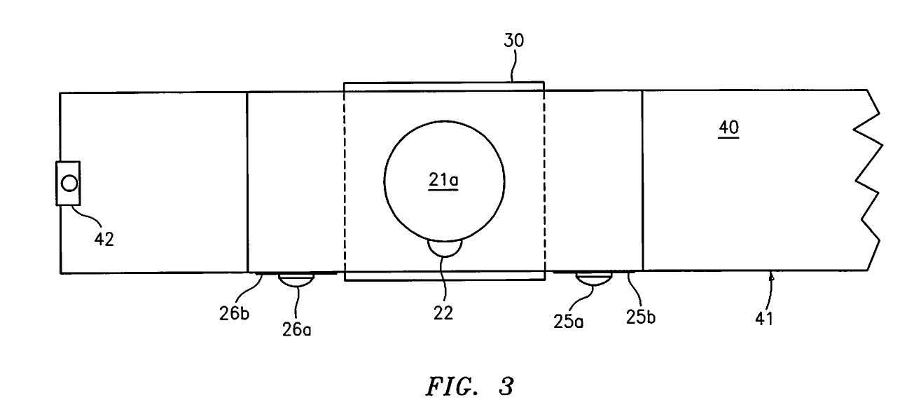

FIG. 2 is a side view of the drywall apparatus assembled in a first orientation, according to an embodiment of the present invention. FIG. 3 is a top view of the drywall apparatus assembled in the first orientation and mounted upon a T-square, according to an embodiment of the present invention.

Referring to FIGS. 2 and 3, the drywall cutting apparatus 10 is assembled in a first orientation, in which the attachment screw 22 is inserted through attachment hole 33. As the user slides the cutting apparatus along the length of the T-square stem 40, using knob assembly 21, the T-square is held in place, and the first and second cutting wheels 25b and 26b cut along a path that is parallel to an edge 41 of the T-square stem 40 without contacting the edge 41. This allows the user to produce a straight cut in a sheet of drywall without dulling the first and second cutting wheels 25b and 26b or damaging the T-square stem 40. The T-square stem 40 preferably includes an end stop 42 that prevents the drywall cutting apparatus 10 from sliding off the T-square stem 40 when in use.

FIG. 4 is a top view of the drywall apparatus assembled in a second orientation and mounted upon the T-square, according to an embodiment of the present invention. The main body 20 of the apparatus in the first orientation is rotated 180 degrees in order to assemble the apparatus in the second orientation.

FIG. 4 illustrates an embodiment in which the attachment screw 22 is inserted through attachment hole 32 in the second orientation. The attachment screw 22 extends through the sliding mount 30 (as shown in FIG. 2) to secure and fix the drywall cutting apparatus 10 at a position along the length of the T-square stem 40. The first and second cutting wheels 25b and 26b are oriented to cut the drywall along a cut line that is perpendicular to the T-square stem 40 as a user slides the entire T-square along an edge of the drywall.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A drywall cutting apparatus comprising:
a slidable mount having a top surface and a bottom surface, wherein a channel is integrated into the bottom surface and utilized for a slidable engagement;
a body having at least one side surface, wherein the body is mounted on the top surface of the slidable mount; and
at least one cutting wheel mounted on the at least one side surface of the body, wherein the at least one cutting wheel is a wheel-shaped blade that cuts as the apparatus is moved across a surface.

2. The drywall cutting apparatus of claim 1, wherein the body is mounted via a fixed projection that extends perpendicularly outward from the top surface of the slidable mount and through an aperture that runs through the body.

3. The drywall cutting apparatus of claim 2, wherein the fixed projection comprises a bolt, and the body is fixed over the slidable mount via a knob assembly that engages the bolt at a top surface of the body.

4. The drywall cutting apparatus of claim 1, wherein the at least one cutting wheel is rotatably mounted to the body via a screw that engages an aperture in the side surface of the body, and the at least one cutting wheel extends below the bottom surface of the slidable mount.

5. The drywall cutting apparatus of claim 1, wherein the body is capable of rotating on the top surface of the slidable mount.

6. The drywall cutting apparatus of claim 1, wherein the body is disposed in a first orientation on the slidable mount when the at least one cutting wheel runs in a direction parallel to the direction of the channel.

7. The drywall cutting apparatus of claim 6, wherein the body is disposed in a second orientation on the slidable mount when the at least one cutting wheel runs in a direction perpendicular to the direction of the channel.

8. The drywall cutting apparatus of claim 6, wherein the body in the first orientation is rotated 180 degrees to the second orientation.

9. The drywall cutting apparatus of claim 7, further comprising an attachment screw that extends through apertures in both the body and the slidable mount and fixes the body in at least one of the first orientation and the second orientation.

10. The drywall cutting apparatus of claim 9, wherein, in the second orientation, the attachment screw fixes the slidable body in place when in the slidable engagement.

11. The drywall cutting apparatus of claim 1, wherein the channel comprises two ledges that run along, and extend perpendicularly inward from, respective walls of the channel.

12. A drywall cutting apparatus comprising:
a mounting device comprising a slidable mount having a top surface and a bottom surface, wherein a channel is integrated into the bottom surface and utilized for a slidable engagement, a body having at least one side surface, wherein the body is mounted on the top surface of the slidable mount, and at least one cutting wheel rotatably mounted on the at least one side surface of the body, wherein the at least one cutting wheel is a wheel-shaped blade that cuts as the device is moved across a surface; and
a T-square comprising a stem upon which the mounting device is slidably engaged, and an end stop that prevents the device from sliding off the stem when in use.
